(19) United States
(12) Patent Application Publication
(10) Pub. No.: US 2014/0272606 A1
(43) Pub. Date: Sep. 18, 2014

(54) LITHIUM-ION SECONDARY BATTERY AND ELECTROLYTE THEREOF

(71) Applicant: Ningde Amperex Technology Limited, Ningde (CN)

(72) Inventors: Chunbo CHU, Ningde (CN); Chenghua FU, Ningde (CN); Fenggang ZHAO, Ningde (CN); Azhong WANG, Ningde (CN); Changlong HAN, Ningde (CN); Shite YE, Ningde (CN)

(73) Assignee: Ningde Amperex Technology Limited, Ningde (CN)

(21) Appl. No.: 14/195,791

(22) Filed: Mar. 3, 2014

(30) Foreign Application Priority Data
Mar. 18, 2013 (CN) 201310085382.8

(51) Int. Cl. H01M 10/0567; H01M 10/0525

(52) U.S. Cl. CPC H01M 10/0567; H01M 10/0525
USPC 429/332; 429/188; 429/200

(57) ABSTRACT

The present disclosure provides a lithium-ion secondary battery and an electrolyte thereof. The electrolyte comprises a lithium salt, a non-aqueous solvent, and an additive at least containing 1,3-propyl sultone (PS) and a compound of isocyanurate structure represented by formula (1), formula (2) or formula (3);

[chemical structure]

in formula (1), n is a positive integer from 1 to 3; in formula (2), n is a positive integer from 1 to 3, R₁ is an alkyl of linear chain or branched chain having carbon atoms from 1 to 6, hydrogen atoms in the alkyl can be substituted by fluorine atoms partly or wholly; in formula (3), n is a positive integer from 1 to 3, R₁ and R₂ are alkyls of linear chain or branched chain having carbon atoms from 1 to 6, hydrogen atoms in the alkyls can be substituted by fluorine atoms partly or wholly.

### REFERENCE TO RELATED APPLICATIONS

The Present Application claims priority to Chinese Patent Application No. CN 201310085382.8 filed on Mar. 18, 2013, the content of which is fully incorporated in its entirety herein.

### FIELD OF THE PRESENT DISCLOSURE

The present disclosure relates to a secondary battery, and more specifically to a lithium-ion secondary battery and an electrolyte thereof.

### BACKGROUND OF THE PRESENT DISCLOSURE

Although a lithium-ion secondary battery has advantages such as high working voltage, long cycle-life and fast charging speed and the like, with development of technology, a lithium-ion secondary battery having a higher energy density is demanded. Improving working voltage of the lithium-ion secondary battery is one of effective ways.

Lithium metal oxide as positive electrode active material has strong oxidizability at high voltage level after a lithium-ion secondary battery is charged, thereby easily resulting in oxidation reaction with an electrolyte, which leads to decomposition of the electrolyte. Oxidation and decomposition of the electrolyte is intensified at the positive electrode plate with a tendency of high voltage of the lithium-ion secondary battery. Cycle performance of the battery descends owing to oxidation and decomposition of the electrolyte in the condition of high temperature.

Therefore, the key to resolve deterioration of high temperature cycle performance of the lithium-ion secondary battery is to inhibit oxidation reaction between the electrolyte and the positive electrode active material. In the lithium-ion secondary battery, non-aqueous organic solvent and additives which are vinylene carbonate (VC) and fluorinated ethylene carbonate (FEC) are usually used to improve cycle performance. FIG. 1 illustrates cycle performance with different voltages at 45° C. using non-aqueous organic solvent and additives which are vinylene carbonate (VC) and fluorinated ethylene carbonate (FEC).

It can be seen from FIG. 1, when voltage is lower than 4.2V, vinylene carbonate (VC) and fluorinated ethylene carbonate (FEC) can really effectively improve cycle performance, but when voltage is higher than 4.4V, cycle performance is remarkably degraded in the condition of high temperature. It can be seen from FIG. 2 that swelling rate is remarkably increased when voltage is 4.4V, that is, storage performance with voltage of 4.4V at high temperature is much worse than that with voltage of 4.2V.

Therefore, it is necessary to provide a lithium-ion secondary battery and an electrolyte thereof which have good storage performance and good cycle performance in the condition of high temperature and high voltage.

### SUMMARY OF THE PRESENT DISCLOSURE

In view of the problems existing in the background technology, an object of the present disclosure is to provide a lithium-ion secondary battery and an electrolyte thereof, which can inhibit oxidation reaction between the electrolyte and a positive electrode active material so as to improve cycle performance and storage performance in the condition of high temperature and high voltage.

In order to attain the above object, in a first aspect of the present disclosure, the present disclosure provides a electrolyte of a lithium-ion secondary battery which comprises a lithium salt, a non-aqueous solvent, and an additive at least containing 1,3-propyl sultone (PS) and a compound of isocyanurate structure, the compound of isocyanurate structure in the additive is represented by the following formula (1), formula (2) or formula (3);

[chemical structure]

in the formula (1), n is a positive integer from 1 to 3;

[chemical structure]

in the formula (2), n is a positive integer from 1 to 3, R₁ is an alkyl of linear chain or branched chain having carbon atoms from 1 to 6, hydrogen atoms in the alkyl can be substituted by fluorine atoms partly or wholly;

[chemical structure]

in the formula (3), n is a positive integer from 1 to 3, R₁ and R₂ are alkyls of linear chain or branched chain having carbon atoms from 1 to 6, hydrogen atoms in the alkyls can be substituted by fluorine atoms partly or wholly.

In a second aspect of the present disclosure, the present disclosure provides a lithium-ion secondary battery which comprises a positive electrode plate; a negative electrode plate; a separator interposed between the positive electrode plate and the negative electrode plate; and an electrolyte; the electrolyte is the electrolyte of the lithium-ion secondary battery according to the first aspect of the present disclosure.

The present disclosure has following beneficial effects.

The lithium-ion secondary battery and the electrolyte thereof provided by the present disclosure can inhibit oxidation reaction between the electrolyte and the positive electrode active material, thereby improving cycle performance and storage performance in the condition of high temperature and high voltage.

### BRIEF DESCRIPTION OF THE FIGURES

FIG. 1 was a cycle performance graph with different voltages at 45° C. using non-aqueous organic solvent and additives of vinylene carbonate (VC) and fluorinated ethylene carbonate (FEC).

FIG. 2 was a swelling rate graph of storage with different voltages at 85° C. for 24 h using non-aqueous organic solvent and additives of vinylene carbonate (VC) and fluorinated ethylene carbonate (FEC).

### DETAILED DESCRIPTION

Hereinafter a lithium-ion secondary battery and an electrolyte thereof and embodiments according to the present disclosure are described in details.

Firstly an electrolyte of a lithium-ion secondary battery according to a first aspect of the present disclosure is described.

An electrolyte of a lithium-ion secondary battery according to a first aspect of the present disclosure comprises a lithium salt, a non-aqueous solvent, and an additive at least containing 1,3-propyl sultone (PS) and a compound of isocyanurate structure, the compound of isocyanurate structure in the additive is represented by the following formula (1), formula (2) or formula (3);

[chemical structure]

in the formula (1), n is a positive integer from 1 to 3;

[chemical structure]

in the formula (2), n is a positive integer from 1 to 3, R₁ is an alkyl of linear chain or branched chain having carbon atoms from 1 to 6, hydrogen atoms in the alkyl can be substituted by fluorine atoms partly or wholly;

[chemical structure]

in the formula (3), n is a positive integer from 1 to 3, R₁ and R₂ are alkyls of linear chain or branched chain having carbon atoms from 1 to 6, hydrogen atoms in the alkyls can be substituted by fluorine atoms partly or wholly.

Preferably, in the electrolyte of the lithium-ion secondary battery according to the first aspect of the present disclosure, the compound of isocyanurate structure represented by the formula (1) comprises 1,3,5-Tri-(2-propenyl)-isocyanurate, 1,3,5-Tri-(3-butenyl)-isocyanurate, 1,3,5-Tri-(4-pentenyl)-isocyanurate; the compound of isocyanurate structure represented by the formula (2) comprises 1,3-di-(2-propenyl)-5-methyl-isocyanurate, 1,3-di-(3-butenyl)-5-methyl-isocyanurate, 1,3-di-(4-pentenyl)-5-methyl-isocyanurate, 1,3-di-(2-propenyl)-5-ethyl-isocyanurate, 1,3-di-(3-butenyl)-5-ethyl-isocyanurate, 1,3-di-(4-pentenyl)-5-ethyl-isocyanurate; the compound of isocyanurate structure represented by the formula (3) comprises 1-(2-propenyl)-3,5-di-methyl-isocyanurate, 1-(3-butenyl)-3,5-di-methyl-isocyanurate, 1-(4-pentenyl)-3,5-di-methyl-isocyanurate, 1-(2-propenyl)-3,5-di-ethyl-isocyanurate, 1-(3-butenyl)-3,5-di-ethyl-isocyanurate, 1-(4-pentenyl)-3,5-di-ethyl-isocyanurate, 1-(2-propenyl)-3,5-di-fluoromethyl-isocyanurate, 1-(2-propenyl)-3,5-di-trifluoromethyl-isocyanurate. The compound of isocyanurate structure more preferably is 1-(2-propenyl)-3,5-di-methyl-isocyanurate, 1-(3-butenyl)-3,5-di-methyl-isocyanurate, 1-(4-pentenyl)-3,5-di-methyl-isocyanurate, 1-(2-propenyl)-3,5-di-ethyl-isocyanurate, 1-(3-butenyl)-3,5-di-ethyl-isocyanurate, 1-(4-pentenyl)-3,5-di-ethyl-isocyanurate, 1-(2-propenyl)-3,5-di-fluoromethyl-isocyanurate, 1-(2-propenyl)-3,5-di-trifluoromethyl-isocyanurate, 1,3-di-(2-propenyl)-5-methyl-isocyanurate, 1,3-di-(3-butenyl)-5-methyl-isocyanurate, 1,3-di-(4-pentenyl)-5-methyl-isocyanurate, 1,3-di-(2-propenyl)-5-ethyl-isocyanurate, 1,3-di-(3-butenyl)-5-ethyl-isocyanurate, 1,3-di-(4-pentenyl)-5-ethyl-isocyanurate. The compound of isocyanurate structure further preferably is 1-(2-propenyl)-3,5-di-methyl-isocyanurate, 1-(3-butenyl)-3,5-di-methyl-isocyanurate, 1-(4-pentenyl)-3,5-di-methyl-isocyanurate, 1-(2-propenyl)-3,5-di-ethyl-isocyanurate, 1-(3-butenyl)-3,5-di-ethyl-isocyanurate, 1-(4-pentenyl)-3,5-di-ethyl-isocyanurate.

The greater the number of alkenyls in cycle of the compound of isocyanurate structure is, especially the compound of isocyanurate structure containing three alkenyls the higher the impedance of electrode plates of the battery after polymerization to form a film is, especially at a lower temperature, thereby affecting cycle performance of the lithium-ion secondary battery.

In the electrolyte of the lithium-ion secondary battery according to the first aspect of the present disclosure, preferably, a weight percentage of the compound of isocyanurate structure in the electrolyte is 0.1%˜5%. More preferably, the weight percentage of the compound of isocyanurate structure in the electrolyte is 0.3%˜1.0%.

If a content of the compound of isocyanurate structure in the electrolyte is too high, complexation between nitrogen atoms in the compound of isocyanurate structure and metallic atoms is too compact, so an impedance of the battery is increased, thereby affecting the cycle performance of the battery. Furthermore, the compound of isocyanurate structure has alkenyl functional group which tends to result in a too thick protective film by polymerization, therefore the impedance of the battery is increased and the cycle performance of the battery is affected. If the content of the compound of isocyanurate structure in the electrolyte is too low, complexation between nitrogen atoms in the compound of isocyanurate structure and metallic atoms is not compact enough, so a reaction between the electrolyte and the positive electrode plate cannot be effectively prevented and thus high temperature cycle performance of the battery can not be effectively improved.

In the electrolyte of the lithium-ion secondary battery according to the first aspect of the present disclosure, a weight percentage of 1,3-propyl sultone in the electrolyte is 0.3%˜10%, preferably 2%˜7%.

In the electrolyte of the lithium-ion secondary battery according to the first aspect of the present disclosure, the non-aqueous solvent comprises a cyclic carbonate ester and a chain carbonate ester. The cyclic carbonate ester has a higher dielectric constant, and can effectively react with lithium ions to form a solvated lithium ion. The chain carbonate ester has a lower viscosity and can improve low-temperature performance of the electrolyte. The cyclic carbonate ester is selected from at least one of ethylene carbonate (EC), propylene carbonate (PC), γ-Butyrolactone (γ-BL) and 2,3-Butylene carbonate (BC). The chain carbonate ester is selected from at least one of dimethyl carbonate (DMC), diethyl carbonate (DEC), ethyl methyl carbonate (EMC), methyl propyl carbonate (MPC) and dipropyl carbonate (DPC).

In the electrolyte of lithium-ion secondary battery according to the first aspect of the present disclosure, the lithium salt is selected from LiN(CₓF₂ₓ₊₁SO₂)(C_{y}F_{2y+1}SO₂) (where x, y is positive integer), LiPF₆, LiBF₄, LiBOB, LiAsF₆, LiN(CF₃SO₂)₂, LiCF₃SO₃, LiClO₄ or a combination thereof.

In the electrolyte of the lithium-ion secondary battery according to the first aspect of the present disclosure, a concentration of the lithium salt is 0.5M˜2M, preferably is 1M.

Next a lithium-ion secondary battery according to a second aspect of the present disclosure is described.

According to a second aspect of the present disclosure, a lithium-ion secondary battery comprises a positive electrode plate; a negative electrode plate; a separator interposed between the positive electrode plate and the negative electrode plate; and an electrolyte; the electrolyte is the electrolyte of the lithium-ion secondary battery according to the first aspect of the present disclosure.

Then embodiments of the lithium-ion secondary battery and the electrolyte thereof according to the present disclosure are described.

### Example 1

Preparation of a positive electrode plate of a lithium-ion secondary battery: lithium cobaltate, conductive carbon (SuperP), poly-vinylidene fluoride (PVDF) as an adhesive, in a weight ratio of 96:2.0:2.0, were uniformly mixed with N-methylpyrrolidone (NMP) to form a positive slurry of the lithium-ion secondary battery, which was then coated on an aluminum foil collector with a coating amount of 0.0194 g/cm², baking was then performed at 85° C., which was followed by cold pressing; then after edge-trimming, plate cutting, slitting, baking at 85° C. for 4 h in a condition of vacuum, and welding a tab, the positive electrode plate of the lithium-ion secondary battery was obtained.

Preparation of a negative electrode plate of the lithium-ion secondary battery: graphite, conductive carbon (SuperP), sodium carboxymethyl cellulose (CMC) as a thickening agent, styrene-butadiene rubber (SBR) as an adhesive, in a weight ratio of 96.5:1.0:1.0:1.5 were uniformly mixed with purified water to form a slurry, which was coated on an copper foil collector with a coating amount of 0.0089 g/cm², baking was then performed at 85° C., which was followed by cold pressing; then after edge-trimming, plate cutting, slitting, baking at 110° C. for 4 h in a condition of vacuum, and welding a tab, the negative electrode plate of the lithium-ion secondary battery was obtained.

Preparation of an electrolyte of the lithium-ion secondary battery: the electrolyte used a concentration of 1M of Lithium Hexafluorophosphate (LiPF₆) as a lithium salt, and used ethylene carbonate (EC), propylene carbonate (PC) and diethyl carbonate (DEC) at a weight ratio of 30:30:40 as a non-aqueous organic solvent. The electrolyte further contained an additive, which consists of 3 wt % of 1,3-propyl sultone (PS) and 1 wt % of 1-(2-propenyl)-3,5-di-methyl-isocyanurate.

Preparation of the lithium-ion secondary battery: the obtained positive electrode plate and the negative electrode plate of the lithium-ion secondary battery were wound together with a separator to form a lithium-ion secondary cell having a thickness of 4.2 mm, a width of 34 mm, and a length of 82 mm, then baking was performed at 75° C. for 10 h under vacuum, which was followed by injection of the prepared electrolyte of lithium-ion secondary battery and standby for 24 h. Then charging was performed at a constant current of 0.1 C (160 mA) to 4.3V, then at a constant voltage of 4.3V to a current as low as 0.05 C (80 mA); and discharging was performed at a constant current of 0.1 C (160 mA) to 3.0V. The above charging and discharging were repeated, which was followed by charging at a constant current of 0.1 C (160 mA) to 3.85V, and finally the preparation of the lithium-ion secondary battery was completed.

### Example 2

Preparation of a positive electrode plate of a lithium-ion secondary battery: it was the same as that in the example 1;

Preparation of a negative electrode plate of the lithium-ion secondary battery: it was the same as that in the example 1;

Preparation of an electrolyte of the lithium-ion secondary battery: it was the same as that in the example 1 except that 1-(3-butenyl)-3,5-di-methyl-isocyanurate was used instead of 1-(2-propenyl)-3,5-di-methyl-isocyanurate used in the example 1;

Preparation of the lithium-ion secondary battery: it was the same as that in the example 1.

### Example 3

Preparation of a positive electrode plate of a lithium-ion secondary battery: it was the same as that in the example 1;

Preparation of a negative electrode plate of the lithium-ion secondary battery: it was the same as that in the example 1;

Preparation of an electrolyte of the lithium-ion secondary battery: it was the same as that in the example 1 except that 1,3-di-(2-propenyl)-5-methyl-isocyanurate was used instead of 1-(2-propenyl)-3,5-di-methyl-isocyanurate used in the example 1;

Preparation of the lithium-ion secondary battery: it was the same as that in the example 1.

### Example 4

Preparation of a positive electrode plate of a lithium-ion secondary battery: it was the same as that in the example 1;

Preparation of a negative electrode plate of the lithium-ion secondary battery: it was the same as that in the example 1;

Preparation of an electrolyte of the lithium-ion secondary battery: it was the same as that in the example 1 except that 1,3-di-(3-butenyl)-5-methyl-isocyanurate was used instead of 1-(2-propenyl)-3,5-di-methyl-isocyanurate used in the example 1;

Preparation of the lithium-ion secondary battery: it was the same as that in the example 1.

### Example 5

Preparation of a positive electrode plate of a lithium-ion secondary battery: it was the same as that in the example 1;

Preparation of a negative electrode plate of the lithium-ion secondary battery: it was the same as that in the example 1;

Preparation of an electrolyte of the lithium-ion secondary battery: it was the same as that in the example 1 except that 1-(2-propenyl)-3,5-di-fluoromethyl-isocyanurate was used instead of 1-(2-propenyl)-3,5-di-methyl-isocyanurate used in the example 1;

Preparation of the lithium-ion secondary battery: it was the same as that in the example 1.

### Example 6

Preparation of a positive electrode plate of a lithium-ion secondary battery: it was the same as that in the example 1;

Preparation of a negative electrode plate of the lithium-ion secondary battery: it was the same as that in the example 1;

Preparation of the electrolyte of lithium-ion secondary battery: it was the same as that in the example 1 except that 1,3,5-Tri-(2-propenyl)-isocyanurate was used instead of 1-(2-propenyl)-3,5-di-methyl-isocyanurate used in the example 1;

Preparation of the lithium-ion secondary battery: it was the same as that in the example 1.

### Example 7

Preparation of a positive electrode plate of a lithium-ion secondary battery: it was the same as that in the example 1;

Preparation of a negative electrode plate of the lithium-ion secondary battery: it was the same as that in the example 1;

Preparation of an electrolyte of the lithium-ion secondary battery: it was the same as that in the example 1 except that 0.1 wt % of 1-(2-propenyl)-3,5-di-methyl-isocyanurate was used instead of 1 wt % of 1-(2-propenyl)-3,5-di-methyl-isocyanurate used in the example 1;

Preparation of the lithium-ion secondary battery: it was the same as that in the example 1.

### Example 8

Preparation of a positive electrode plate of a lithium-ion secondary battery: it was the same as that in the example 1;

Preparation of a negative electrode plate of the lithium-ion secondary battery: it was the same as that in the example 1;

Preparation of an electrolyte of the lithium-ion secondary battery: it was the same as that in the example 1 except that 5 wt % of 1-(2-propenyl)-3,5-di-methyl-isocyanurate was used instead of 1 wt % of 1-(2-propenyl)-3,5-di-methyl-isocyanurate used in the example 1;

Preparation of the lithium-ion secondary battery: it was the same as that in the example 1.

### Example 9

Preparation of a positive electrode plate of the lithium-ion secondary battery: it was the same as that in the example 1;

Preparation of a negative electrode plate of the lithium-ion secondary battery: it was the same as that in the example 1;

Preparation of an electrolyte of the lithium-ion secondary battery: it was the same as that in the example 1 except that 0.3 wt % of 1-(2-propenyl)-3,5-di-methyl-isocyanurate was used instead of 1 wt % of 1-((2-propenyl))-3,5-di-methyl-isocyanurate used in the example 1;

Preparation of the lithium-ion secondary battery: it was the same as that in the example 1.

### Example 10

Preparation of a positive electrode plate of a lithium-ion secondary battery: it was the same as that in the example 1;

Preparation of a negative electrode plate of the lithium-ion secondary battery: it was the same as that in the example 1;

Preparation of an electrolyte of the lithium-ion secondary battery: it was the same as that in the example 1 except that 3 wt % of 1-(2-propenyl)-3,5-di-methyl-isocyanurate was used instead of 1 wt % of 1-((2-propenyl))-3,5-di-methyl-isocyanurate used in the example 1;

Preparation of the lithium-ion secondary battery: it was the same as that in the example 1.

### Example 11

Preparation of a positive electrode plate of a lithium-ion secondary battery: it was the same as that in the example 1;

Preparation of a negative electrode plate of the lithium-ion secondary battery: it was the same as that in the example 1;

Preparation of an electrolyte of the lithium-ion secondary battery: it was the same as that in the example 1 except that 0.3 wt % of 1,3-propyl sultone was used instead of 3 wt % of 1,3-propyl sultone used in the example 1;

Preparation of the lithium-ion secondary battery: it was the same as that in the example 1.

### Example 12

Preparation of a positive electrode plate of a lithium-ion secondary battery: it was the same as that in the example 1;

Preparation of a negative electrode plate of the lithium-ion secondary battery: it was the same as that in the example 1;

Preparation of an electrolyte of the lithium-ion secondary battery: it was the same as that in the example 1 except that 10 wt % of 1,3-propyl sultone was used instead of 3 wt % of 1,3-propyl sultone used in the example 1;

Preparation of the lithium-ion secondary battery: it was the same as that in the example 1.

### Comparative Example 1

Preparation of a positive electrode plate of a lithium-ion secondary battery: it was the same as that in the example 1;

Preparation of a negative electrode plate of the lithium-ion secondary battery: it was the same as that in the example 1;

Preparation of an electrolyte of the lithium-ion secondary battery: it was the same as that in the example 1 except that there was no additive;

Preparation of the lithium-ion secondary battery: it was the same as that in the example 1.

### Comparative Example 2

Preparation of a positive electrode plate of a lithium-ion secondary battery: it was the same as that in the example 1;

Preparation of a negative electrode plate of the lithium-ion secondary battery: it was the same as that in the example 1;

Preparation of an electrolyte of the lithium-ion secondary battery: it was the same as that in the example 1 except that the additive was only 3 wt % of 1,3-propyl sultone (PS);

Preparation of the lithium-ion secondary battery: it was the same as that in the example 1.

### Comparative Example 3

Preparation of a positive electrode plate of a lithium-ion secondary battery: it was the same as that in the example 1;

Preparation of a negative electrode plate of the lithium-ion secondary battery: it was the same as that in the example 1;

Preparation of an electrolyte of the lithium-ion secondary battery: it was the same as that in the example 1 except that an additive was only 1 wt % of 1-(2-propenyl)-3,5-di-methyl-isocyanurate;

Preparation of the lithium-ion secondary battery: it was the same as that in the example 1.

Finally tests and results of the tests of the examples 1-12 and the comparative examples 1-3 of the lithium-ion secondary battery of the present disclosure were presented.

(1) Testing of capacity retention rate: respectively at 25° C. and 45° C., each of the lithium-ion secondary batteries of the examples 1-12 and the comparative examples 1-3 was firstly charged to 4.4V at a constant current of 0.7 C (1120 mA), and secondly charged to a current less than 0.05 C (80 mA) at a constant voltage of 4.4V, and then discharged to 3.0V at a constant current of 0.5 C (800 mA). The discharging capacity of the present time was recorded as a first cycle discharging capacity. For the test, the lithium-ion secondary batteries were charged and discharged for 800 cycles according to the above manner, the 800^{th} cycle discharging capacity was recorded.
Capacity retention rate (%)=[the 800^{th} cycle discharging capacity/the first cycle discharging capacity]*100%
(2) Testing of swelling rate: each of the lithium-ion secondary batteries of the examples 1-12 and the comparative examples 1-3 was charged to 4.4V at a constant current of 0.1 C (160 mA), then charged to a current less than 0.05 C (80 mA) at a constant voltage of 4.4V. A thickness was tested before storage, which was recorded as a pre-storage thickness, and then a thickness was tested after storage at 85° C. for 24 h, which was recorded as a post-storage thickness. Swelling rate (%)=[(the post-storage thickness−the pre-storage thickness)/the pre-storage thickness]*100%

TABLE 1
Capacity retention rate and swelling rate using different additives

| | | | | capacity | | |
|---|---|---|---|---|---|---|
| | | isocyanurate structure | | retention | | |
| | PS | additive | | rate (%) | | swelling |
| | additive | type | content | 25° C. | 45° C. | rate (%) |
| example 1 | 3.0% | 1-(2-propenyl)-3,5-di- | 1.0% | 82 | 70 | 16 |
| | | methyl-isocyanurate | | | | |
| example 2 | 3.0% | 1-(3-butenyl)-3,5-di- | 1.0% | 83 | 68 | 18 |
| | | methyl-isocyanurate | | | | |
| example 3 | 3.0% | 1,3-di-(2-propenyl)-5- | 1.0% | 77 | 71 | 12 |
| | | methyl-isocyanurate | | | | |
| example 4 | 3.0% | 1,3-di-(3-butenyl)-5- | 1.0% | 72 | 72 | 13 |
| | | methyl-isocyanurate | | | | |
| example 5 | 3.0% | 1-(2-propenyl)-3,5- | 1.0% | 74 | 69 | 16 |
| | | di-fluoromethyl- | | | | |
| | | isocyanurate | | | | |
| example 6 | 3.0% | 1,3,5-Tri-(2-propenyl)- | 1.0% | 62 | 72 | 6 |
| | | isocyanurate | | | | |
| example 7 | 3.0% | 1-(2-propenyl)-3,5-di- | 0.1% | 85 | 62 | 26 |
| | | methyl-isocyanurate | | | | |
| example 8 | 3.0% | 1-(2-propenyl)-3,5-di- | 5.0% | 65 | 70 | 8 |
| | | methyl-isocyanurate | | | | |
| example 9 | 3.0% | 1-(2-propenyl)-3,5-di- | 0.3% | 83 | 68 | 20 |
| | | methyl-isocyanurate | | | | |
| example 10 | 3.0% | 1-(2-propenyl)-3,5-di- | 3.0% | 76 | 72 | 10 |
| | | methyl-isocyanurate | | | | |
| example 11 | 0.3% | 1-(2-propenyl)-3,5-di- | 1.0% | 80 | 65 | 36 |
| | | methyl-isocyanurate | | | | |
| example 12 | 10.0% | 1-(2-propenyl)-3,5-di- | 1.0% | 72 | 70 | 12 |
| | | methyl-isocyanurate | | | | |
| comparative | 0% | None | 0% | 33 | 12 | 102 |
| example 1 | | | | | | |
| comparative | 3.0% | None | 0% | 81 | 51 | 30 |
| example 2 | | | | | | |
| comparative | 0% | 1-(2-propenyl)-3,5-di- | 1.0% | 79 | 55 | 35 |
| example 3 | | methyl-isocyanurate | | | | |

Table 1 illustrated capacity retention rates and swelling rates of the lithium-ion secondary batteries of the examples 1-12 and the comparative examples 1-3 of the present disclosure, which reflected cycle performances in the condition of 25° C. and 45° C., 0.7 C charging/0.5 C discharging, 3.0-4.4V and storage performance after storing for 24 h at 4.4V, 85° C. It can be seen from the examples 1-12 and the comparative examples 1-3 that adding an additive of isocyanurate structure to the electrolyte of the lithium-ion secondary battery can effectively improve high temperature cycle performance and storage performance of the lithium-ion secondary battery. It can be seen from the examples 1, 7-10 and the comparative example 1 that adding an additive of 0.1 wt % of isocyanurate structure into the electrolyte of lithium-ion secondary battery cannot improve high temperature cycle performance (the example 7) and high temperature storage performance of the lithium-ion secondary battery effectively enough; when weight percentage of the additive of isocyanurate structure in the electrolyte of lithium-ion secondary battery was increased to 1%, high temperature cycle performance and high temperature storage performance of the lithium-ion secondary battery (the example 1) can be effectively improved; when weight percentage of the additive of isocyanurate structure in the electrolyte of lithium-ion secondary battery was increased to 5%, cycle performance of the lithium-ion secondary battery at room temperature (25° C.) became poor (the example 8), but high temperature storage performance became better.

It can be seen from the example 1 and the example 6 that the cycle performance with 1,3,5-Tri-(2-propenyl)-isocyanurate was worse than that with 1-(2-propenyl)-3,5-di-methyl-isocyanurate at 25° C. for the same content (1%), the cycle performance with 1,3,5-Tri-(2-propenyl)-isocyanurate was slightly better than that with 1-(2-propenyl)-3,5-di-methyl-isocyanurate at 45° C. for the same content (1%), the high temperature storage performance with 1,3,5-Tri-(2-propenyl)-isocyanurate was more excellent than that with 1-(2-propenyl)-3,5-di-methyl-isocyanurate for the same content (1%).

It can be seen from the example 1 and the comparative examples 1-3 that either 1-(2-propenyl)-3,5-di-methyl-isocyanurate or 1,3-propyl sultone can solely improve cycle performance and storage performance of the battery in the condition of high voltage and high temperature, but cycle performance and storage performance of the lithium-ion secondary battery in the condition of high temperature and high voltage still need to be improved. When 1-(2-propenyl)-3,5-di-methyl-isocyanurate and 1,3-propyl sultone were used together, the lithium-ion secondary battery had more excellent cycle performance and storage performance in the condition of high temperature and high voltage.

Adding the compound of isocyanurate structure into the electrolyte of the lithium-ion secondary battery can remarkably improve cycle performance and storage performance of the battery in the condition of high temperature and high voltage, however, the mechanism of which was not clear. Some possible reasons were shown below: (1) isocyanurate structure has three nitrogen atoms, each nitrogen atom has a pair of lone pair electrons that can effectively complex with high valent metallic atoms (Ni, Co, Mn and the like), complexation between the nitrogen atoms and the high valent metallic atoms (Ni, Co, Mn and the like) can effectively reduce the capability of oxidizing the electrolyte of the high valent metallic atoms;(2) after complexation between the isocyanurate structure and the positive electrode, the alkenyl functional group can result in polymerization so as to form a passivation film on a surface of the positive electrode plate, thereby further reducing the capability of oxidizing the electrolyte of the high valent metallic atoms. Therefore, the compound of isocyanurate structure decreased the reaction between the positive electrode and the electrolyte, thereby effectively improving cycle performance and storage performance of the battery in the condition of high temperature and high voltage.

1,3-propyl sultone can improve high temperature storage performance of the lithium-ion secondary battery; the compound of isocyanurate structure can complex with high valent metallic atoms of the positive electrode through nitrogen atoms so as to form a passivation film on the surface of the positive electrode; but high temperature storage performance and high temperature cycle performance in conditions of high temperature and high voltage still need to be improved, 1,3-propyl sultone cannot solely effectively weaken decomposition reaction at an interface between the positive electrode and the electrolyte. When the compound of isocyanurate structure and 1,3-propyl sultone were present together, the battery had more excellent high temperature storage performance and high temperature cycle performance, the mechanism of which was not clear, possible reason was shown below: a more flexible passivation film can be formed through ring-opening of 1,3-propyl sultone on the surface of the positive electrode, but a rigid passivation film having isocyanurate heterocycle can be formed through complexation or alkenyl free-radical polymerization of the compound of isocyanurate structure at the surface of the positive electrode, this composite film had excellent mechanical performance on the surface of the positive electrode, which resulted in an excellent interface performance between the positive electrode and the electrolyte, thereby effectively improving high temperature storage performance and high temperature cycle performance of the lithium-ion secondary battery.

What is claimed is:

1. An electrolyte of a lithium-ion secondary battery, comprising: a lithium salt and a non-aqueous solvent, and further comprising an additive at least containing 1,3-propyl sultone (PS) and a compound of isocyanurate structure, the compound of isocyanurate structure in the additive being represented by the following formula (1), formula (2) or formula (3); [chemical structure]
in the formula (1), n being a positive integer from 1 to 3; [chemical structure]
in the formula (2), n being a positive integer from 1 to 3, R₁ being an alkyl of linear chain or branched chain having carbon atoms from 1 to 6, hydrogen atoms in the alkyl can being substituted by fluorine atoms partly or wholly; [chemical structure]
in the formula (3), n being a positive integer from 1 to 3, R₁ and R₂ being alkyls of linear chain or branched chain having carbon atoms from 1 to 6, hydrogen atoms in the alkyls can being substituted by fluorine atoms partly or wholly.

2. The electrolyte of the lithium-ion secondary battery according to claim 1, wherein the compound of isocyanurate structure represented by the formula (1) comprises 1,3,5-Tri-(2-propenyl)-isocyanurate, 1,3,5-Tri-(3-butenyl)-isocyanurate, 1,3,5-Tri-(4-pentenyl)-isocyanurate;
the compound of isocyanurate structure represented by the formula (2) comprises 1,3-di-(2-propenyl)-5-methyl-isocyanurate, 1,3-di-(3-butenyl)-5-methyl-isocyanurate, 1,3-di-(4-pentenyl)-5-methyl-isocyanurate, 1,3-di-(2-propenyl)-5-ethyl-isocyanurate, 1,3-di-(3-butenyl)-5-ethyl-isocyanurate, 1,3-di-(4-pentenyl)-5-ethyl-isocyanurate;
the compound of isocyanurate structure represented by the formula (3) comprises 1-(2-propenyl)-3,5-di-methyl-isocyanurate, 1-(3-butenyl)-3,5-di-methyl-isocyanurate, 1-(4-pentenyl)-3,5-di-methyl-isocyanurate, 1-(2-propenyl)-3,5-di-ethyl-isocyanurate, 1-(3-butenyl)-3,5-di-ethyl-isocyanurate, 1-(4-pentenyl)-3,5-di-ethyl-isocyanurate, 1-(2-propenyl)-3,5-di-fluoromethyl-isocyanurate, 1-(2-propenyl)-3,5-di-trifluoromethyl-isocyanurate.

3. The electrolyte of the lithium-ion secondary battery according to claim 2, wherein the compound of isocyanurate structure is 1-(2-propenyl)-3,5-di-methyl-isocyanurate, 1-(3-butenyl)-3,5-di-methyl-isocyanurate, 1-(4-pentenyl)-3,5-di-methyl-isocyanurate, 1-(2-propenyl)-3,5-di-ethyl-isocyanurate, 1-(3-butenyl)-3,5-di-ethyl-isocyanurate, 1-(4-pentenyl)-3,5-di-ethyl-isocyanurate, 1-(2-propenyl)-3,5-di-fluoromethyl-isocyanurate, 1-(2-propenyl)-3,5-di-trifluoromethyl-isocyanurate, 1,3-di-(2-propenyl)-5-methyl-isocyanurate, 1,3-di-(3-butenyl)-5-methyl-isocyanurate, 1,3-di-(4-pentenyl)-5-methyl-isocyanurate, 1,3-di-(2-propenyl)-5-ethyl-isocyanurate, 1,3-di-(3-butenyl)-5-ethyl-isocyanurate, 1,3-di-(4-pentenyl)-5-ethyl-isocyanurate.

4. The electrolyte of the lithium-ion secondary battery according to claim 3, wherein the compound of isocyanurate structure further is 1-(2-propenyl)-3,5-di-methyl-isocyanurate, 1-(3-butenyl)-3,5-di-methyl-isocyanurate, 1-(4-pentenyl)-3,5-di-methyl-isocyanurate, 1-(2-propenyl)-3,5-di-ethyl-isocyanurate, 1-(3-butenyl)-3,5-di-ethyl-isocyanurate, 1-(4-pentenyl)-3,5-di-ethyl-isocyanurate.

5. The electrolyte of the lithium-ion secondary battery according to claim 1, wherein a weight percentage of the compound of isocyanurate structure in the electrolyte is 0.1%˜5%.

6. The electrolyte of the lithium-ion secondary battery according to claim 5, wherein the weight percentage of the compound of isocyanurate structure in the electrolyte is 0.3%˜1.0%.

7. The electrolyte of the lithium-ion secondary battery according to claim 1, wherein a weight percentage of 1,3-propyl sultone in the electrolyte is 0.3%˜10%.

8. The electrolyte of the lithium-ion secondary battery according to claim 7, wherein a weight percentage of 1,3-propyl sultone in the electrolyte is 2%˜7%.

9. The electrolyte of the lithium-ion secondary battery according to claim 1, wherein the non-aqueous solvent comprises a cyclic carbonate ester and a chain carbonate ester.

10. The electrolyte of the lithium-ion secondary battery according to claim 1, wherein the lithium salt is selected from LiN(CF₂ₓ₊₁SO₂)(C_{y}F_{2y+1}SO₂) (where x, y is positive integer), LiPF₆, LiBF₄, LiBOB, LiAsF₆, LiN(CF₃SO₂)₂, LiCF₃SO₃, LiClO₄ or a combination thereof.

11. A lithium-ion secondary battery, comprising:
a positive electrode plate;
a negative electrode plate;
a separator interposed between the positive electrode plate and the negative electrode plate; and
an electrolyte comprising: a lithium salt and a non-aqueous solvent, and further comprising an additive at least containing 1,3-propyl sultone (PS) and a compound of isocyanurate structure, the compound of isocyanurate structure in the additive being represented by the following formula (1), formula (2) or formula (3); [chemical structure]
in the formula (1), n being a positive integer from 1 to 3; [chemical structure]
in the formula (2), n being a positive integer from 1 to 3, R₁ being an alkyl of linear chain or branched chain having carbon atoms from 1 to 6, hydrogen atoms in the alkyl can being substituted by fluorine atoms partly or wholly; [chemical structure]
in the formula (3), n being a positive integer from 1 to 3, R₁ and R₂ being alkyls of linear chain or branched chain having carbon atoms from 1 to 6, hydrogen atoms in the alkyls can being substituted by fluorine atoms partly or wholly.

12. The electrolyte of the lithium-ion secondary battery according to claim 11, wherein the compound of isocyanurate structure represented by the formula (1) comprises 1,3,5-Tri-(2-propenyl)-isocyanurate, 1,3,5-Tri-(3-butenyl)-isocyanurate, 1,3,5-Tri-(4-pentenyl)-isocyanurate;
the compound of isocyanurate structure represented by the formula (2) comprises 1,3-di-(2-propenyl)-5-methyl-isocyanurate, 1,3-di-(3-butenyl)-5-methyl-isocyanurate, 1,3-di-(4-pentenyl)-5-methyl-isocyanurate, 1,3-di-(2-propenyl)-5-ethyl-isocyanurate, 1,3-di-(3-butenyl)-5-ethyl-isocyanurate, 1,3-di-(4-pentenyl)-5-ethyl-isocyanurate;
the compound of isocyanurate structure represented by the formula (3) comprises 1-(2-propenyl)-3,5-di-methyl-isocyanurate, 1-(3-butenyl)-3,5-di-methyl-isocyanurate, 1-(4-pentenyl)-3,5-di-methyl-isocyanurate, 1-(2-propenyl)-3,5-di-ethyl-isocyanurate, 1-(3-butenyl)-3,5-di-ethyl-isocyanurate, 1-(4-pentenyl)-3,5-di-ethyl-isocyanurate, 1-(2-propenyl)-3,5-di-fluoromethyl-isocyanurate, 1-(2-propenyl)-3,5-di-trifluoromethyl-isocyanurate.

13. The electrolyte of the lithium-ion secondary battery according to claim 12, wherein the compound of isocyanurate structure is 1-(2-propenyl)-3,5-di-methyl-isocyanurate, 1-(3-butenyl)-3,5-di-methyl-isocyanurate, 1-(4-pentenyl)-3,5-di-methyl-isocyanurate, 1-(2-propenyl)-3,5-di-ethyl-isocyanurate, 1-(3-butenyl)-3,5-di-ethyl-isocyanurate, 1-(4-pentenyl)-3,5-di-ethyl-isocyanurate, 1-(2-propenyl)-3,5-di-fluoromethyl-isocyanurate, 1-(2-propenyl)-3,5-di-trifluoromethyl-isocyanurate, 1,3-di-(2-propenyl)-5-methyl-isocyanurate, 1,3-di-(3-butenyl)-5-methyl-isocyanurate, 1,3-di-(4-pentenyl)-5-methyl-isocyanurate, 1,3-di-(2-propenyl)-5-ethyl-isocyanurate, 1,3-di-(3-butenyl)-5-ethyl-isocyanurate, 1,3-di-(4-pentenyl)-5-ethyl-isocyanurate.

14. The electrolyte of the lithium-ion secondary battery according to claim 13, wherein the compound of isocyanurate structure further is 1-(2-propenyl)-3,5-di-methyl-isocyanurate, 1-(3-butenyl)-3,5-di-methyl-isocyanurate, 1-(4-pentenyl)-3,5-di-methyl-isocyanurate, 1-(2-propenyl)-3,5-di-ethyl-isocyanurate, 1-(3-butenyl)-3,5-di-ethyl-isocyanurate, 1-(4-pentenyl)-3,5-di-ethyl-isocyanurate.

15. The electrolyte of the lithium-ion secondary battery according to claim 12, wherein a weight percentage of the compound of isocyanurate structure in the electrolyte is 0.1%˜5%.

16. The electrolyte of the lithium-ion secondary battery according to claim 15, wherein the weight percentage of the compound of isocyanurate structure in the electrolyte is 0.3%˜1.0%.

17. The electrolyte of the lithium-ion secondary battery according to claim 12, wherein a weight percentage of 1,3-propyl sultone in the electrolyte is 0.3%˜10%.

18. The electrolyte of the lithium-ion secondary battery according to claim 17, wherein a weight percentage of 1,3-propyl sultone in the electrolyte is 2%˜7%.

19. The electrolyte of the lithium-ion secondary battery according to claim 12, wherein the non-aqueous solvent comprises a cyclic carbonate ester and a chain carbonate ester.

20. The electrolyte of the lithium-ion secondary battery according to claim 12, wherein the lithium salt is selected from LiN(CₓF₂ₓ₊₁SO₂)(C_{y}F_{2y+1}SO₂) (where x, y is positive integer), LiPF₆, LiBF₄, LiBOB, LiAsF₆, LiN(CF₃SO₂)₂, LiCF₃SO₃, LiClO₄ or a combination thereof.
